(19) United States
(12) Patent Application Publication
(10) Pub. No.: US 2005/0065721 A1
(43) Pub. Date: Mar. 24, 2005

(54) Device and process for displaying navigation information

(76) Inventors: Ralf-Guido Herrtwich, Kleinmachnow (DE); Michael Maile, Half Moon Bay, CA (US); Thomas Bock, Palo Alto, CA (US); Wilhelm Wilke, Dornstadt (DE); Wieland Holfelder, Sunnyvale, CA (US)

Correspondence Address: PENDORF & CUTLIFF, 5111 MEMORIAL HIGHWAY, TAMPA, FL, 33634-7356, US

(21) Appl. No.: 10/950,124

(22) Filed: Sep. 24, 2004

(30) Foreign Application Priority Data
Sep. 24, 2003 (DE) 103 44 120.4

(51) Int. Cl. G01C 21/26

(52) U.S. Cl. 701/207; 340/995.1

(57) ABSTRACT

The invention concerns a process and a device for displaying navigation information on a projection surface in a vehicle, including a navigation system, which by means of a satellite supported system continuously acquires position information for the vehicle, and which by means of an image producing unit produces navigation information or driving directions obtained from the navigation system within an image of the vehicle environment, wherein a reliability value for the position data is determined, and the image producing unit produces the navigation information in various display modes depending upon the reliability value.

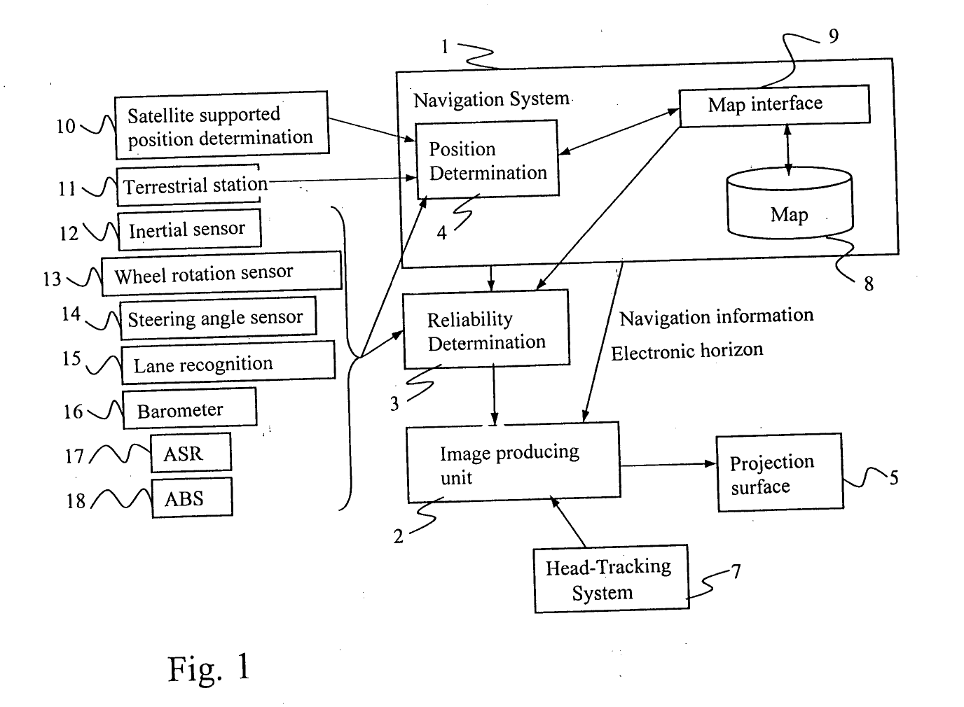

### BACKGROUND OF THE INVENTION

1. Field of the Invention

The invention concerns a device and a process for displaying navigation information for navigating a vehicle in a representation of the vehicle environment.

2. Related Art of the Invention

DE 101 38 719 A1 discloses a process and a device for displaying driving directions in a vehicle, wherein driving directions acquired via a navigation system are projected onto the windshield or blended into an image of the environment recorded by a video camera and shown on the display of the navigation system. The driving directions are represented in the form of virtual dashed lines or arrows, which from the perspective of the driver or, as the case may be, the camera, indicate on the windshield or on the display the path to be traveled in registry with the streets ahead of the vehicle. The placement or orientation of the displayed driving directions in the image of the vehicle environment is undertaken on the basis of the navigation system's satellite supported position determination. In order for the display to be correct from the perspective of the driver or, as the case may be, the camera, even the case of driving up or down mountains, an appropriate shortening or as the case may be lengthening of the lines is computed with the aid of a 3D terrain model and based on the attitude of the vehicle and the GPS position data of the vehicle—in certain cases supported by auxiliary navigation.

A satellite system supported position determination for the vehicle provides, due to unavoidable errors, position indications which deviate from the actual position of the vehicle. While such deviations can be minimized by the use of auxiliary navigation, greater errors with regard to position determination—for example as a result of reflection, or areas in which the reception of satellite signals is interfered with—larger deviations are not avoidable, so that environmentally based driving directions cannot be brought sufficiently into correspondence or synchrony with the true environment. This means, the virtual marked street guidance displayed to the driver on the projection surface appears, for example, displaced beside the actual roadway; in certain conditions it is even possible that the road with the oncoming traffic is marked, or the image may jump back and forth. This is of course irritating to the driver and distracts his attention from the actual traffic situation.

If driving directions are displayed in an image of the vehicle environment (this could be a video image on the display or a heads-up display in association with the windshield) for example in the form of lines or arrows oriented according to the positioning of the streets, or as markers based upon permanent points of the vehicle environment, it is important that these directions are inserted with the greatest possible continuity of precision into the image of the vehicle environment.

Of a precise integration of the driving directions into the image of the vehicle environment cannot be guaranteed due to erroneous position data, then the display of the driving directions is displaced, or offset in the image relative to the actual area to be marked, whereby the directions intended for orientation of the driver are no longer easily interpreted. Besides the fact that it is annoying and distracting for the driver when the representation of the driving directions “jump” relative to the intended position depending upon the precision of the position data, incorrectly placed driving directions even cause confusion when for example a turn indication jumps back and forth in the image of the environment between a closer and a more distant side street.

The problem of a marker deviating from the actual object can be solved for example by a pattern recognition system, which is designed for recognition of the most diverse objects, including streets.

WO 03 005 102 A1 describes a Heads-Up-Display system and a process for marking objects in the vehicle environment locationally corrected in relation to the perspective a vehicle occupant. The locationally correct or locationally indexed display based on the perspective of a vehicle occupant occurs in relation to him by a sensor-detected head and eye position. The objects to be displayed or marked generally concern other traffic participants or traffic signs. The objects to be displayed or marked in the vehicle environment are identified using cameras and pattern recognition, and suitably modeled for display on the windshield. Further, a visual translation of navigation data or driving directions is contemplated, wherein in this case the vehicle track to be traveled or, as the case may be, a turn, is displayed on the Heads-Up-Display in the driver's perspective.

Using only means for pattern recognition, a turn is in many cases not positively identifiable—possibly due to preceding vehicles or other objects blocking the field of view, so that the virtual marking of the turn is again in these cases dependent upon the, with the above-described disadvantages, error prone position data of the navigation system.

### SUMMARY OF THE INVENTION

It is the task of the invention to provide a device and a process with a continuously reliable easily interpreted display of navigation information within the display of the vehicle environment.

The task is solved by the characteristics of dependent claims 1 and 9. Advantageous embodiments can be found in the dependent claims.

The inventive process makes the display of the navigation information obtained from the navigation system dependent upon the positional data for a vehicle obtained via a satellite supported system. By the taking into consideration the reliability or precision of the position data or readings, the navigation information can always be displayed in the most comprehensible form for the driver. The inventive image generating unit produces navigation information or driving directions obtained from the navigation system continuously in a manner of representation which is most comprehensible for the driver in accordance with the achievable reliability of the positional data and is associated with the least amount of distraction.

In the case of highly precise positional data, the navigation or driving directions can be produced by the image producing unit, for example an easily understood virtual line guide following the course or progression of the street, and be blended precisely into the image of the vehicle environment on a projection surface in the vehicle. If the reliability of the position data is however not sufficient of a satisfactory presentation of navigation data with direct regard to the environment, the image generating unit switches to other display types, for example to schematic arrows or virtual traffic signs, which symbols the driver does not expect to optically conform to the changing environment. Schematically or abstract depicted navigation information is displayed on a fixed location on the projection surface or, in regard to the driving directions, follows the environment with strong sluggishness or lethargy. The more abstract modes of representation, which, in comparison to the environmentally indexed representations, have a reduced force of expression, can be compensated for, for example, by auxiliary acoustic constructions.

The determination of the reliability of the positional data obtained by the satellite supported system occurs preferably by a determination and evaluation of statistical values, which satellite supported systems conventionally provide regarding the precision of the determined position. These values are received by the navigation system along with the positional determination, and from this are transmitted to the device for determination of reliability. The reliability itself can be expressed as a statistical value in various orders, for example as standard deviation or as a probability of error.

The positional data is preferably made more precise by correction data provided by a ground station, wherein also the reliability is corrected with values for the reliability of these greater precisions. Therein the device for ascertaining the position data obtains the data for correction of the position through the navigation system, which receives these data and also the data regarding reliability of these position corrections from the ground station, and transmits the data for correction of the reliability to the device for determining the reliability. In the correction of the reliability determination, therein there can also be entered the correction value or amount by which the position data was improved. The navigation system obtains this differential value from the device for determining the position data.

By position corrections, which are possible by receiving signals from geographically fixed ground stations, for example by differential GPS, the precision of the position data or information can advantageously be improved by several meters. This helps, in those areas in which reception from such stations is possible, in order to determine the position of a vehicle with a high reliability. In such areas the inventive system can present object-related navigation information on the projection surface in sufficient correspondence with the objects in the vehicle environment. The position indications or data for the vehicle can also be further improved by comparing the determined position with a digital map (lane-matching). Such a position comparison also leads again to an increased reliability for the position data, wherein the greater the precision of the digital map, the greater the improvement in the position determination.

It is of advantage, when the position data is made more precise by signals obtained by the vehicle, wherein the reliability is corrected corresponding to the value for the reliability of this increased precision. For this the vehicle located sensors are connected with the device for determining the position data, which receives from the sensors the data for correction of the position data. The device for determining the reliability receives from the vehicle sensors data for the appropriate correction of the reliability. These data relate to the reliability of the sensors or, as the case may be, their measurements or readings.

The advantage of position correction with the aid of vehicle located sensors is comprised above all therein, that therewith an interrupted reception of the satellite signal necessary for position determination can be bridged over or compensated for. In cities, the satellite signals can be reflected by high and dense construction, or in forests can be partially in a transmission shadow due to dense foliage, so that the position necessary for the display of driving directions—which are to be displayed with reference to the actual environment—can no longer be sufficiently precisely determined. In the case of reception of less than 4 satellites, or due to multi-path effects, greater differences result between the actual and the calculated position of the vehicle. Multi-path effects can be corrected for example by differential calculation using a second antenna for receipt of satellite position data in the vehicle, with the greatest possible separation or distance from the first antenna.

Advantageous methods for supplementation and correction of the absolute position data, as they are received by satellite supported systems or by a ground station, with relative position data, include odometers and dead reckoning, or coupled navigation which operates with data regarding steering angle and wheel rotations or, as the case may, be acceleration. These signals are produced by a steering angle sensor and wheel rotation sensor and/or by an inertial sensor. Also useful, for more precise evaluation of the tire revolutions, is information from the anti-slip control or the anti-lock brake system. Signals for the relative elevation change are provided by a barometer.

A particularly advantageous possibility for improving the relative precision of the position data is comprised in the employment of a video supported driving lane recognition, of which the results allow a correction of the position data in the lateral direction. When using night vision devices this is also reliability possible at night. An improvement in the precision of the position data in the lateral direction is of particular significance particularly for a display of navigation information as virtual road or lane markings, so that the virtual marking does not accidentally indicate an adjacent traffic lane or even an oncoming or opposing lane.

In addition to the data which these sensors provide for position correction, data regarding the reliability of the measurements can be obtained. These could include for example manufacturer indications regarding the sensors, time or distance dependent weighted values or—in the case of the video supported recognition system—values for the recognition reliability or confidence co-efficient or certainty.

When using the above-described methods it becomes possible to achieve such precise position data that in areas, in which for example at least 7 satellites can be received, virtual lane markings can be displayed for longer stretches of road. With this mode of display there can be displayed in the virtual markings of the lane also speed information such as in certain cases brake processes to be initiated, for example prior to curves, in that the markings for certain speed ranges or areas can be variously color coded or by having, adjacent the markings, a display of the quantified speed information.

Nevertheless, despite the supplemental backup methods as have already been described, the vehicle position can only be followed for a limited amount of time with sufficient reliability or confidence. With increasing distance from the last absolute or, as the case may be, satellite supported detected measurement point, the error increases also in these relative methods. If over a longer period of time a sufficient number of satellites for achieving a reliable position determination are not available, or if multi-path effects interfere with the position determination, and if no ground station for receipt of, correction data is available, then the reliability of the position determination drops, so that the image generating device for the display of the virtual driving directions no longer produces reliable correlation with the environment.

Thus it is advantageous to undertake the reliability dependent display of the navigation information according to three reliability steps or levels. Thus, in the case of high reliability, the inventive image producing unit produces the navigation information in an environmentally related display; in the case of a low reliability in a symbolic representation; and in the case of an average reliability—depending upon the navigation information to be presented—either in environmentally based or a symbolic representation.

The three levels of differentiation of presentation modes for navigation information takes sufficiently into consideration the requirement for a presentation of navigation information in a way which does not distract the driver. If a sufficient precision of the environmental basing cannot be achieved, due to the position deviation in the lateral direction being for example for longer durations greater than a half or a whole meter, then the presentation of the driving directions occurs symbolically, for example in the case of turning as a bent arrow, which does not change its position on the projection surface, however in certain cases grows with increasing proximity to the navigation point. In place of schematic arrows there can also be displayed virtual directional signs or traffic signs.

If the precision of the position determination lies in an intermediate range—for example in an area of between one and five meters—, then these symbolic displays on the projection surface can, on the basis of strongly attenuated position information, be slowly moved closer to or approximated to the navigation point.

In the longitudinal direction one can set up the requirements of the reliability or precision of the position determination different than in the lateral direction. For example in the longitudinal direction a range of 3 or 4 meters can be evaluated as highly reliable and a range of between 4 and 12 meters as average reliability. The reliability of elevation data is essentially of interest only in the case that sufficiently precise maps are available for height information. Otherwise the vertical dimension need not be evaluated, or a relatively rough graduation suffices for occasional adjustment or reconciling.

The switching between the different display modes occurs respectively only then, when the reliability lies for a certain period of time in the corresponding reliability range or realm. The period of time for maintaining a high reliability for switching into the environmentally based display is therein, for safety reasons, to be selected to be longer, than the period of time in which to be in the medium or a low reliability prior to switching into a symbolic display of the navigation information.

For the environment based display, the navigation information are preferably projected onto suitable objects in the displayed image of the vehicle environment corrected positionally or locationally for the perspective of the driver or with regard to the viewing angle of a camera.

Therein the projection surface can be either
a display surface, upon which an image of the vehicle environment recorded by a camera can be displayed, onto which the display of the navigation information produced by the image producing unit is integrated or blended in, or
half-mirrored or semi-permeable data viewing glasses or visor or
the windshield in association with a heads-up display, into which the navigation information produced by the image producing unit can be blended.

The positionally correct display of the environmentally based navigation information is therein, in the case of the combination of display and camera, preferably achieved by determination of the relative position of the camera to the environment by means of existing internal sensors. If the information regarding the known position of the camera together with the position information of the internal sensor and the map information belonging to the navigation information (electronic horizon), the image producing unit can determine the correct location for a virtual marking of objects in the vehicle environment, which are to be marked for the navigation information, and project these positionally correct on the displayed image on the projection surface.

The positionally correct display of the environmentally based navigation information by means of the Heads-Up-Display or by means of half-mirror or semi-permeable data glasses or visor is achieved in the case of this embodiment by determining the position and orientation of the driver head relative to the environment by means of a Head-Tracking-System.

Therewith the projection of the virtual driving directions is positioned and oriented relative to the environment particularly precisely according to the view or perspective of the driver. The results are however also achieved, when the image production unit works with an estimated, fixed position for the driver head.

In the environment based display of navigation information, objects of the vehicle environment are marked virtually as positionally correct as possible relative to a certain angle of observation—be it that of the camera or that of the driver—by means of a projection surface. As objects, there are to be considered not only road or lane contours, it is also conceivable to orient or align the navigation on buildings or to provide information regarding prominent points or special points of interest (POI). The latter can for example be co-noted or captioned with interesting information specifically addressed to the fellow passengers. The optical referencing of these objects occurs likewise in a display, which makes allowance for the reliability of the position determination.

Further types of navigation information concern for example construction sites, accidents, detours or status. This information is, as with the other environment information, obtained from the digital map, which is regularly in communication with a geographic or terrestrial center and the digital map is provided and updated with this information.

For a best possible interpretable or understandable display of navigation information, it is useful not to display certain information that the navigation system has, in order not to distract or confuse the driver. These include for example road sections which are not visible to the driver such as for example curves or tunnels or underpasses. Thus it is advantageous when the image producing system does not display navigation information which—from the perspective of the driver or the camera—concern hidden objects, or it displays these in a manner distinguishably different from the navigation information which relates to visible objects. This can be preferably accomplished when the image producing unit obtains from the navigation system information for distinguishing objects which, from the view of or perspective of the driver or the camera, are hidden, in comparison to objects which are observable.

The hidden or not observable objects can then either be completely omitted from the display or they can, for example, be displayed in dashed lines or paled shading. Besides the information from the digital map, it is possible to also drawn upon further information for fading out obscured objects. A distronic sensor can be used for example for measuring the distance to a preceding vehicle, so that a virtual lane marking can then be displayed for example only up to this vehicle.

### BRIEF DESCRIPTION OF THE DRAWINGS

The invention will now be described in greater detail on the basis of the FIGURE:

The FIGURE shows a preferred embodiment with a navigation system 1 for receiving position data from a satellite supported system 10, which position data are processed by the device 4 for position determination of the navigation system. Together with the position data the navigation system 1 receives data regarding the precision or accuracy of this position data. These data are relayed from the navigation system for further processing in the device 3 for determining the reliability of the positioning determination.

### DETAILED DESCRIPTION OF THE INVENTION

The navigation device 1 receives or obtains from the ground station 11 further data for correction of the position determination, which are processed by the device 4 for position determination, as well as data regarding reliability of this correction, which the navigation system transmits to the device 3 for determination of reliability.

The inertial sensor 12, the steering angle sensor 14, the tire revolution sensor 13—together with the anti-slip control 17 and the anti-block brake system 18—, the lane recognition 15 and the barometer 16 provide to the device 4 for position determination signals or input for further correction of the data. The same sensors and system supply the device 3 for determination of reliability with reliability determinations of its respective inputs for position correction, from which the device 3 calculates a new value for the reliability of the position data.

The device 4 for position determination transmits the position data to the map interface 9, which therewith on the basis of the digital map 8 carries out a position comparison or matching (lane matching). The map interface 9 returns the corrected positioning data to the device 4 for position determination and sends a value for the correction of the reliability to the device 3 for determination of reliability.

With the corrected position data the map interface furthermore produces from the digital map 8, according to the desired target location, navigation information or driving directions and all information and environment information necessary for an image display of the navigation device, which via an interface of the navigation system are output as a so-called electronic horizon to the image producing unit 2.

The image producing unit 2 produces, from the navigation information and the electronic horizon, image or iconic displays of the navigation information or driving directions, which are projected upon the projection surface 5. Depending upon the reliability of the determined position data, the image producing unit 2 distinguishes or differentiates between the environment based and the symbolic representation mode. The environment based display marks observable objects virtually on the projection surface 5, wherein this is based upon blending markings into the projection surface in the vehicle in correspondence with objects located outside, and doing this from the view or perspective of the observer. This mode of display is thus, in accordance with the invention, employed only for very reliable position data, since for this the correspondence of the real position of the vehicle with the virtual position on the digital map is of importance.

The symbolic display mode in the case of lower reliability of the position determination is limited to the static or locationally-fixed display of information or directions on the projection surface. In the case of somewhat adequate precision of the position determination and suitability of the driving directions, the symbolic displayed objects can be loosely associated with the environment.

The projection surface can be, for example, a windshield, in which the navigation information is reflected using a Heads-Up-Display. For a precise, positionally correct projection there is provided a Head-Tracking-System 7 which provides to the image producing unit 2 information regarding the position and orientation of the driver's head.

1. A process for displaying navigation information on a projection surface (5) in a vehicle, the vehicle including a navigation system (1), the process comprising
continuously obtaining position information data for the vehicle via a satellite supported system (10),
using an image producing unit (2), producing a display of navigation information acquired from the navigation system (1), and
displaying this navigation information in an image of the vehicle environment on a the projection surface (5),
wherein a determination is made as to the reliability of the position data, and wherein the image producing unit (2) varies the mode of display of the navigation information depending upon the level of reliability.

2. A process according to claim 1, wherein the reliability is determined using statistical values which the satellite supported system (10) provides regarding accuracy of the determined position.

3. A process according to claim 1, wherein the position data is improved in precision by correction data from a ground station (11), and the reliability is corrected with values for the reliability of these improvements in precision.

4. A process according to claim 1, wherein the position data is improved in precision by signals obtained onboard the vehicle, and the reliability is corrected using values for the reliability of these improvements in precision.

5. A process according to claim 4, wherein the signals obtained onboard the vehicle involve acceleration and/or a relative elevation change and/or the product of lane recognition.

6. A process according to claim 1, wherein the image producing unit (2) produces the reliability dependent display of the navigation information
environment based, in the case of a high reliability,
symbolically, in the case of a low reliability, and
in the case of an intermediate reliability—depending upon the navigation information to be displayed—either environment based or symbolic.

7. A process according to claim 6, wherein in the environment based display the navigation information is projected upon suitable objects in the image of the vehicle environment positionally correct in relation to the perspective of the driver or the angle of view of a camera (6).

8. A process according to claim 6, wherein navigation information which concerns objects hidden or obscured—from the view of the driver or the camera (6)—is not displayed or is displayed in a different manner than the navigation information which relates to observable objects.

9. A device for displaying navigation information upon a projection surface (5) in a vehicle, including
a navigation system (1), for continuously obtaining position data for the vehicle via a satellite supported system (10) and
an image producing unit (2) for producing navigation information from output of the navigation system and displaying this in an image of the vehicle environment upon the projection surface (5),
a device for determination of the reliability of the position data (3), which device is connected with the image producing unit (2), for producing various modes of display for the navigation information, the display mode depending upon the degree of reliability.

10. A device according to claim 9, wherein the device for determination of reliability (3) is in communication, via the navigation system, with the satellite supported system (10) for receiving data regarding the accuracy of the position data.

11. A device according to claim 9, wherein a ground station (11) is in communication with the device for producing position data or information (4) for receiving data for correction of the position data, and, via the navigation system, with a device for determining the reliability (3) for receiving of data for correction of the reliability.

12. A device according to claim 9, wherein the vehicle onboard sensors are in communication with the device for determination of the position data (4) for receiving data for correction of the position data, and with the device for determination of the reliability (3) for receiving data regarding correction of the reliability.

13. A device according to claim 12, wherein the vehicle onboard sensors include an inertial sensor (12) and/or a tire revolution sensor (13) in combination with a steering angle sensor (14) and/or a barometer (16) and/or a video supported lane recognition system (15).

14. A device according to claim 9, wherein the display of the navigation information produced by the image producing device (2), depending upon the level of reliability of the information,
in the case of a high reliability is environment based,
in the case of a low reliability is symbolic, and
in the case of intermediate reliability, is either environment based or symbolic, depending upon the navigation information to be displayed.

15. A device according to claim 9, wherein the projection surface (5) is a display, upon which the image of the vehicle environment recorded by the camera (6) is to be reproduced, into which the display of the navigation information produced by the image producing unit (2) is blended.

16. A device according to claim 15, wherein in the environment based display mode the navigation information is projected upon suitable objects in the vehicle environment in correct positional arrangement by determination of the relative position of the camera (6) to the environment via an inertial sensor (12).

17. A device according to claim 9, wherein the projection surface is a semi-transparent or half-mirrored data viewing eye glasses or mask, or a windshield, in connection with a Heads-Up-Display, in which the navigation information produced by the image producing unit (2) can be blended in.

18. A device according to claim 17, wherein in the environment based display the navigation information is projected upon suitable objects in the vehicle environment in correct positional arrangement by determination of the position and orientation of the driver's head relative to the environment using a Head-Tracking-System (7).

19. A device according to claim 9, wherein the image producing unit (2) obtains from the navigation system (1) information for discriminating between objects which are obscure and out of view of the driver or the camera (6) and objects which are observable.
